(19) United States
(12) Patent Application Publication
(10) Pub. No.: US 2016/0379087 A1
(43) Pub. Date: Dec. 29, 2016

(54) METHOD FOR DETERMINING A SIMILARITY VALUE BETWEEN A FIRST IMAGE AND A SECOND IMAGE

(71) Applicant: Metaio GmbH, Munich (DE)

(72) Inventor: Oliver Ruepp, Munich (DE)

(21) Appl. No.: 15/103,228

(22) PCT Filed: Dec. 12, 2013
(86) PCT No.: PCT/EP2013/076387

§ 371 Date: Jun. 9, 2016

(51) Int. Cl. G06K 9/62; G06K 9/46; G06K 9/52

(52) U.S. Cl. CPC G06K 9/6215; G06K 9/52; G06K 9/4671; G06K 2009/4666

(57) ABSTRACT

A method for determining a similarity value between a first image and a second image, comprises the steps of providing a first plurality of point pairs, wherein each pair of the first plurality of point pairs has two image points in the first image, determining, for each pair of the first plurality of point pairs, a sign parameter and a weight associated with the respective pair of the first plurality of point pairs according to image intensities of the two image points of the respective pair of the first plurality of point pairs, providing a second plurality of point pairs, wherein each pair of the second plurality of point pairs has two image points in the second image and is corresponding to one of the point pairs of the first plurality of point pairs, determining, for each pair of the second plurality of point pairs, a sign parameter associated with the respective pair of the second plurality of point pairs according to image intensities of the two image points of the respective pair of the second plurality of point pairs, determining a score parameter according to weights associated with at least part of the first plurality of point pairs, wherein only point pairs are considered which have the same sign parameter as the respective corresponding pair of the second plurality of point pairs, determining a normalization parameter according to weights associated with the first plurality of point pairs or a part of the first plurality of point pairs, and determining a similarity value according to the score parameter and the normalization parameter.

### BACKGROUND

The present disclosure is related to a method for determining a similarity value between a first image and a second image.

Processes such as image processing, camera pose estimation and/or digital reconstruction of a real environment are common and challenging tasks in many applications or fields, such as robotic navigation, 3D object reconstruction, augmented reality visualization, etc. As an example, it is known that systems and applications, such as augmented reality (AR) systems and applications, could enhance information of a real environment by providing a visualization of overlaying computer-generated virtual information with a view of the real environment. For example, vision based methods are known as robust and popular methods for computing a camera pose or motion. The vision based methods (such as vision based tracking) compute a pose (or motion) of a camera relative to an environment based on, e.g., an image of the environment captured by the camera and, e.g., based on a second image such as a reference image. Such vision based methods are relying on the captured images and require detectable visual features in the images.

The performance (e.g. speed, accuracy and robustness) of vision based tracking, registration or detection solutions often relies on a similarity measure. The similarity measure, as is known in the art, computes the degree of difference between reference visual information and current visual information (e.g. difference between a reference image and a current image). A current image is, for example, an image of a real environment captured by a camera, the pose of which shall be determined with respect to a part of the real environment. Common examples of image similarity measures include the sum-of-squared differences (SSD), sum-of-absolute differences (SAD), normalized cross-correlation (NCC), and mutual information. The result of a similarity is a real number.

Each of the common similarity measures has its own advantages and drawbacks. For example, SSD is fast to evaluate and well-suited for nonlinear optimization, but it is not robust against outliers. SAD is also fast to evaluate and robust against outliers, but it is not suited for non-linear optimization. Mutual Information is suited for optimization and very robust against outliers, but it is very slow to evaluate.

Several methods exist to compute image similarity scores, and each of them is very well suited for specific tasks. Probably the most well-known similarity metrics are:
Sum of squared differences (SSD)
Sum of absolute differences (SAD)
Zero-mean cross correlation (ZNCC)
Mutual information (Ml)

Their typical fields of usage, advantages, and drawbacks are:

Sum of squared differences:
Is continuous, and for this reason its used frequently for implementing fast nonlinear optimization algorithms.
Is not robust to scale and offset shift in measurements.
Is not robust to monotonically increasing mappings on measurements.
Is not robust to outliers, since using SSD in an optimization problem implicitly assumes a Gaussian distribution of errors on measurements.
Is fast to evaluate

Sum of absolute differences:
Is not continuous at the origin, thus making it unsuitable for nonlinear optimization (even though there are ways to amend this problem).
Is not robust to scale and offset shift in measurements.
Is not robust to monotonically increasing mappings on measurements.
Is somewhat robust to outliers
Is fast to evaluate.
Zero-mean cross correlation:
Is continuous, can be used for nonlinear optimization even though it can be shown that it is not very well suited for this.
Is robust to scale and offset shift in measurements.
Is not robust to monotonically increasing mappings on measurements.
Is not robust against outliers.
Is fast to evaluate, but slower than SSD or SAD. Mutual information:
Is continuous and can be used for nonlinear optimization.
Is robust to scale and offset shift in measurements.
Is robust to monotonically increasing mappings on measurements.
Is robust against outliers.
Is very slow to evaluate.

A completely different approach to matching images is pursued in the area of feature matching. Typically, for a small image patch to be compared against other patches, a descriptor is computed, and descriptors can be matched against each other. Basically, this is another way to define a similarity measure for small image patches. Two recent and well-known examples for this are BRISK and BRIEF.

The BRIEF descriptor works by randomly choosing pixel pairs from a reference image patch, and comparing the intensities of the involved pixels, which basically yields a binary string of length 512, where each binary indicates whether one pixel is brighter than the other. When this reference image patch is compared against a current image patch, the same pairs are checked in the current image patch, another binary string of length 512 is generated, and the distance of both strings is compared using their Hamming distance.

A very similar approach is taken by the BRISK descriptor. The major difference in comparison to BRIEF is that sampling locations are no longer chosen randomly.

BRISK and BRIEF compute intensity differences between two image points of a pair and convert it to binary. Then, they simply compute Hamming distance between binary strings of a reference image and a current image in order to determine a similarity value between the reference and current images. However, they do not consider weights (i.e. intensity difference between the two points of a pair) for the determination of the similarity value.

Therefore, it would be desirable to have a method for determining a similarity value between a first image and a second image that is quite fast and also robust against outliers.

### SUMMARY

According to an aspect, there is disclosed a method for determining a similarity value between a first image and a second image, comprising providing a first plurality of point pairs, wherein each pair of the first plurality of point pairs has two image points in the first image, determining, for each pair of the first plurality of point pairs, a sign parameter and a weight associated with the respective pair of the first plurality of point pairs according to image intensities of the two image points of the respective pair of the first plurality of point pairs, providing a second plurality of point pairs, wherein each pair of the second plurality of point pairs has two image points in the second image and is corresponding to one of the point pairs of the first plurality of point pairs, determining, for each pair of the second plurality of point pairs, a sign parameter associated with the respective pair of the second plurality of point pairs according to image intensities of the two image points of the respective pair of the second plurality of point pairs, determining a score parameter according to weights associated with at least part of the first plurality of point pairs, wherein only point pairs of the first plurality of point pairs are considered which have the same sign parameter as the respective corresponding pair of the second plurality of point pairs, determining a normalization parameter according to weights associated with the first plurality of point pairs or a part of the first plurality of point pairs, and determining a similarity value according to the score parameter and the normalization parameter.

In contrast to BRISK and BRIEF, as described above, the present invention discloses to use weights (such as absolute values of intensity differences) and further proposes a normalization step for determining a normalized similarity value between the two images. An advantage of using weights is particularly as follows:

Images captured by cameras practically are always affected by noise. For point pairs whose intensity difference is small, noise might lead to the sign of the difference to invert, even though in reality the points (e.g. pixels) are correctly matched. If a weight is not used, the score of the similarity value will be lowered significantly and the impact of noise leads to a disproportional score decrease.

It is possible to use the respective intensity differences as weights. If the intensities of two points are close to each other, the probability for a noise-related matching error is high. Thus, by taking the weights into account and normalizing in the further process, such pixels (i.e. point pairs) that have a high probability of producing false matching values are weighted down and have less influence on the overall score of the similarity value.

According to an embodiment, the sign parameter associated with each one of the point pairs is either positive or negative resulting from a difference between image intensities of the two image points of the respective one of the point pairs.

According to a further embodiment, the weight associated with each one of the point pairs is an absolute value of a difference between image intensities of the two image points of the respective one of the point pairs.

According to an embodiment, the method further comprises the steps of providing a first plurality of image points in the first image, wherein the two image points of each pair of the first plurality of point pairs are a subset of the first plurality of image points in the first image, providing a second plurality of image points in the second image, wherein the two image points of each pair of the second plurality of point pairs are a subset of the second plurality of image points in the second image, determining point correspondences between at least part of the first plurality of image points and at least part of the second plurality of image points, and providing the second plurality of point pairs according to the point correspondences.

For example, the score parameter is determined by summing up the weights associated with at least part of the first plurality of point pairs.

According to an embodiment, the normalization parameter is determined by summing up the weights of all of the point pairs of the first plurality of point pairs.

According to another embodiment, the normalization parameter is determined by summing up the weights of only a part of the point pairs of the first plurality of point pairs.

According to another embodiment, the normalization parameter is determined by summing up the weights of only the point pairs of the first plurality of point pairs that have a respective corresponding point pair in the second plurality of point pairs.

According to an embodiment, the first image and/or the second image is an image of a real environment captured by a camera.

According to another aspect, the invention is also related to a computer program product comprising software code sections which are adapted to perform a method according to the invention. Particularly, the software code sections are contained on a computer readable medium which is non-transitory. The software code sections may be loaded into a memory of one or more processing devices, for example of a mobile device associated with a camera, a personal computer and/or a server computer communicating with such mobile device and/or personal computer. Any used processing device(s) for performing the method may communicate via a communication network, e.g. via a server computer or a point to point communication, as described herein.

### DESCRIPTION OF THE DRAWINGS

Aspects and embodiments of the invention will now be described with respect to the drawings, in which:

FIG. 1 shows a flow diagram of an embodiment of a method for determining a similarity value between a first image and a second image,

FIG. 2 shows a scenario of a reference image (i.e. a first image) and a current image (i.e. a second image) to which a method according to the invention may be applied.

### DETAILED DESCRIPTION

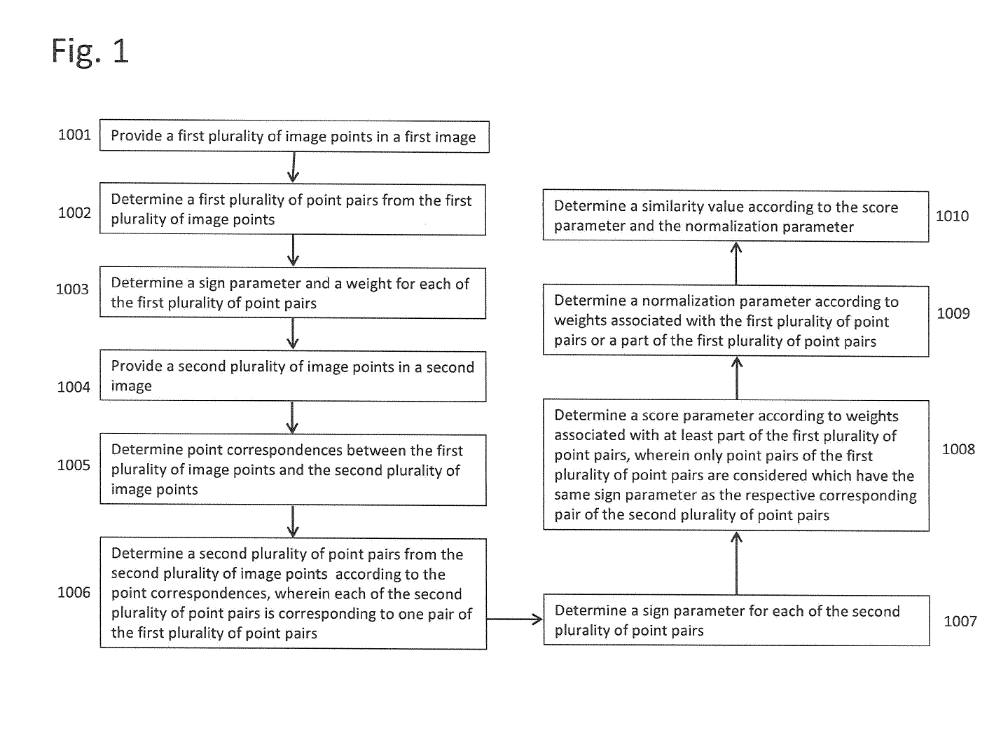

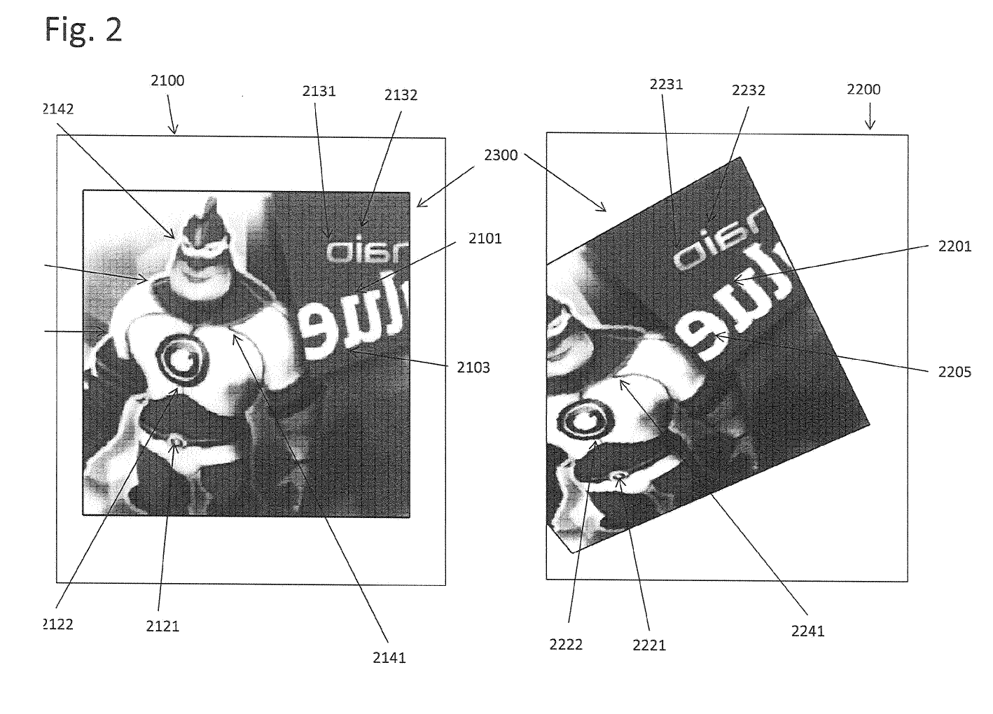

In the following, it is referred to the exemplary embodiments according to FIGS. 1 and 2. FIG. 1 shows a flow diagram of an embodiment of a method for determining a similarity value between a first image and a second image, while FIG. 2 shows a scenario of a reference image (i.e. a first image, as referred to herein) and a current image (i.e. a second image, as referred to herein).

Assuming a scenario according to FIG. 2, a part of a real object 2300 (which is planar in this example) is captured by a camera (not shown) in a current image 2200 (i.e. the second image, as referred to herein). A frontal parallel view of the real planar object 2300 is contained in a reference image 2100 (i.e. the first image, as referred to herein). In this embodiment, the reference image 2100 is generated synthetically.

A first plurality of image points including image points 2111, 2112, 2121, 2122, 2131, 2132, 2141, 2142, 2101 and 2103 in the first image 2100 are provided with respective pixel positions and intensity values in step 1001.

Step 1002 determines a first plurality of point pairs from the first plurality of image points. The first plurality of point pairs is thus a subset of the first plurality of image points. For example, the image points 2111 and 2112 are grouped into point pair Al, the image points 2121 and 2122 are grouped into point pair B1, the image points 2131 and 2132 are grouped into point pair C1, and the image points 2141 and 2142 are grouped into point pair D1. The image points 2101 and 2103 are not grouped into any point pair.

In step 1003, there is determined a sign parameter and a weight for each of the first plurality of point pairs. Particularly, for each pair of the first plurality of point pairs, there is determined a sign parameter and a weight associated with the respective pair of the first plurality of point pairs according to image intensities of the two image points belonging to the respective point pair of the first plurality of point pairs. In this embodiment, the weight is an absolute value of the image intensity difference between the two image points in the respective point pair.

A second plurality of image points including the image points 2221, 2222, 2231, 2232, 2241, 2201 and 2205 in the second image 2200 are provided with pixel positions and intensity values in step 1004.

Step 1005 determines point correspondences between the first plurality of image points and the second plurality of image points. For example, it is possible to determine a homography that could transform the first image 2100 in order to align the real object 2300 in the first image 2100 and in the second image 2200. Then, pixel positions of two image points (one image point in the transformed first image and another image point in the second image) may be compared in order to determine if the two image points correspond to each other.

In the example of FIG. 2, the image points 2221, 2222, 2231, 2232, 2201 and 2241 in the second image 2200 correspond to the image points 2121, 2122, 2131, 2132, 2101 and 2141, respectively, in the first image 2100. The image points 2121 and 2122, and 2131 and 2132 are the image points for point pairs B1 and C1.

A second plurality of point pairs is determined according to the point correspondences in step 1006. In this example, the second plurality of point pairs is determined to include point pair B2 (having image points 2221 and 2222) and point pair C2 (having image points 2231 and 2232). Point pair B2 corresponds to point pair B1 and point pair C2 corresponds to point pair C1. Even though the image point 2141 is belonging to point pair D1 and has corresponding image point 2241 in the second image, image point 2142 in the first image misses a corresponding image point in the second image. Thus, not each of the first plurality of point pairs needs to have a corresponding point pair from the second plurality of point pairs.

Step 1007 determines a sign parameter for each of the second plurality of point pairs. Particularly, for each pair of the second plurality of point pairs, a sign parameter associated with the respective pair of the second plurality of point pairs is determined according to image intensities of the two image points of the respective pair of the second plurality of point pairs. For example, like in step 1003, the sign parameter of each point pair is either positive or negative resulting from a difference between the image intensities of the two image points of the respective point pair. For example, the image intensities of the two image points are subtracted from each other resulting in a positive or negative result, thus having a positive or negative sign, respectively.

According to an embodiment, the weights are respective absolute values of a difference between image intensities of the two image points of the respective point pair. For example, the image intensities of the two image points are subtracted from each other resulting in an absolute value of the subtraction (without positive or negative sign), i.e. in an absolute value of the image intensity difference.

Step 1008 determines a score parameter according to at least part of the determined weights, i.e. weights of at least part of the first plurality of point pairs. For determining the score parameter, a sign parameter associated with each considered pair of the at least part of the first plurality of point pairs is the same as a sign parameter associated with a corresponding pair of the second plurality of point pairs. In other words, for determining the score parameter, only point pairs of the first plurality (i.e. from the first image) and their respective weights are considered which have the same sign parameter as the respective corresponding pair of the second plurality of point pairs. As such, only point pairs of the first plurality and their weights are considered which coincide in sign with their corresponding point pair in the second plurality.

Preferably, the score parameter is computed by summing the weights associated with the considered point pairs. Particularly, the weights only of those pairs which have the same sign as the sign in the corresponding pair are summed up.

Step 1009 then determines a normalization parameter according to weights associated with the first plurality of point pairs or a part of the first plurality of point pairs. In one implementation, the weights associated with all the point pairs in the first plurality of point pairs may be used to determine the value of the normalization parameter. For example, the weights associated with the point pairs A1, B1, C1 and DI are summed up to gain the value of the normalization parameter. In another implementation, the weights associated with a part of the first plurality of point pairs may be used to determine the value of the normalization parameter. For example, only the point pairs in the first plurality of point pairs that have corresponding point pairs in the second plurality of point pairs may be used. In the example of FIG. 2, the weights associated with the point pairs B1 and C1, that have corresponding point pairs B2 and C2, are summed up to determine the value of the normalization parameter.

Step 1010 determines a similarity value according to the score parameter and the normalization parameter determined previously. For example, the similarity value is computed by dividing the score parameter by the normalization parameter. In this example, the higher the similarity value is, the more similar the two images (e.g. the first and second images) are.

Generally, the following aspects and embodiments may be applied in connection with the present invention.

The similarity value may be a real number. It can be used as a similarity measure. It represents a degree of difference between visual information associated with the first image and visual information associated with the second image. The first and second image may be the same image or different images. The visual information may represent a real object captured in the first or second image. The visual information may represent a virtual object.

The first and/or second image may be generated synthetically, for example generated by a computer. The first and/or second image may also be captured by a real camera. In this example, the first and/or second image may capture at least part of a real object or a real environment.

Image points may be extracted or detected from the first and/or second image according to, but not limited to, intensities, gradients, edges, lines, segments, corners, descriptive features and/or any other kind of features, primitives, histograms, polarities or orientations in the first or second image. An image point may be associated with a pixel position and an intensity value. The intensity value (i.e. image intensity) may be a vector (e.g. RGB color information and/or opacity information) or a scalar value (e.g. grey information). When the intensity value is a vector, it may be converted to a scale value.

The sign parameter is either positive (e.g. plus sign) or negative (e.g. minus sign) indicating a difference between image intensities of two image points. The case of equal intensities between the two image points may be considered either as positive or negative. The sign parameter may be a vector or a scale value.

When a point pair A of the first plurality of image points corresponds to a point pair B of the second plurality of image points, this requires that the two image points of the point pair A correspond to the two image points of the point pair B. For determining the sign parameter for the point pair A and its corresponding point pair B, the order of the two image points of the point pair A and the order of the two image points of the corresponding point pair B in mathematical operations (e.g. subtraction) may have to be the same.

Point correspondences between image points in the first image and the second image may be determined, for example, according to homographies. The homographies may map at least part of the first image with at least part of the second image. For example, a planar real object captured in one image could be aligned with the planar real object captured in another image by a homography.

1. A method for determining a similarity value between a first image and a second image, comprising
obtaining a first plurality of point pairs, wherein each pair of the first plurality of point pairs comprises two image points in a first image;
determining, for each pair of the first plurality of point pairs, a sign parameter and a weight according to image intensities of the two image points of the respective pair.
obtaining a second plurality of point pairs, wherein each pair of the second plurality of point pairs comprises two image points in a second image and corresponds to one of the point pairs of the first plurality of point pairs;
determining, for each pair of the second plurality of point pairs, a sign parameter according to image intensities of the two image points of the respective pair;
assigning weights to point pairs of the first plurality of point pairs which have the same sign parameter as the respective corresponding pair of the second plurality of point pairs;
determining a normalization parameter according to weights associated with at least part of the first plurality of point pairs; and
determining a similarity value for the first image and the second image based on assigned weights and the normalization parameter.

2. The method of claim 1, wherein the sign parameter associated with each one of the point pairs is either positive or negative resulting from a difference between image intensities of the two image points of the respective one of the point pairs.

3. The method of claim 1, wherein the weight associated with each one of the point pairs is an absolute value of a difference between image intensities of the two image points of the respective one of the point pairs.

4. (canceled)

5. The method according claim 1, wherein a score parameter is determined by summing up the weights associated with at least some of the first plurality of point pairs.

6. (canceled)

7. The method of claim 1, wherein the normalization parameter is determined by summing up the weights of at least some of the point pairs of the first plurality of point pairs.

8. The method of claim 7, wherein the at least some of the point pairs of the first plurality of point pairs comprises only the point pairs of the first plurality of point pairs that have a corresponding point pair in the second plurality of point pairs.

9. The method of claim 1, wherein at least one of the first and second images is an image of a real environment captured by a camera.

10. (canceled)

11. A non-transitory computer readable medium comprising computer readable code executable by one or more processors to:
obtain a first plurality of point pairs, wherein each pair of the first plurality of point pairs comprises two image points in a first image;
determine, for each pair of the first plurality of point pairs, a sign parameter and a weight according to image intensities of the two image points of the respective pair;
obtain a second plurality of point pairs, wherein each pair of the second plurality of point pairs comprises two image points in a second image and corresponds to one of the point pairs of the first plurality of point pairs;
determine, for each pair of the second plurality of point pairs, a sign parameter according to image intensities of the two image points of the respective pair;
assigning weights to point pairs of the first plurality of point pairs which have the same sign parameter as the respective corresponding pair of the second plurality of point pairs;
determine a normalization parameter according to weights associated with at least part of the first plurality of point pairs; and
determine a similarity value for the first image and the second image based on the assigned weights and the normalization parameter.

12. The non-transitory computer readable medium of claim 11, wherein the sign parameter associated with each one of the point pairs is either positive or negative resulting from a difference between image intensities of the two image points of the respective one of the point pairs.

13. The non-transitory computer readable medium of claim 11, wherein the weight associated with each one of the point pairs is an absolute value of a difference between image intensities of the two image points of the respective one of the point pairs.

14. The non-transitory computer readable medium of claim 11, wherein a score parameter is determined by summing up the weights associated with at least some of the first plurality of point pairs.

15. The non-transitory computer readable medium of claim 11, wherein the normalization parameter is determined by summing up the weights of at least some of the point pairs of the first plurality of point pairs.

16. The non-transitory computer readable medium of claim 15, wherein the at least some of the point pairs of the first plurality of point pairs comprises only the point pairs of the first plurality of point pairs that have a respective corresponding point pair in the second plurality of point pairs.

17. The non-transitory computer readable medium of claim 11, wherein at least one of the first and second images is an image of a real environment captured by a camera.

18. A system for determining a similarity value between a first and second image, comprising:
one or more processors; and
a memory coupled to the one or more processors and comprising computer code executable by the one or more processors to:
obtain a first plurality of point pairs, wherein each pair of the first plurality of point pairs comprises two image points in a first image;
determine, for each pair of the first plurality of point pairs, a sign parameter and a weight according to image intensities of the two image points of the respective pair;
obtain a second plurality of point pairs, wherein each pair of the second plurality of point pairs comprises two image points in a second image and corresponds to one of the point pairs of the first plurality of point pairs;
determine, for each pair of the second plurality of point pairs, a sign parameter according to image intensities of the two image points of the respective pair;
assigning weights to point pairs of the first plurality of point pairs which have the same sign parameter as the respective corresponding pair of the second plurality of point pairs;
determine a normalization parameter according to weights associated with at least part of the first plurality of point pairs; and
determine a similarity value for the first image and the second image based on the assigned weights and the normalization parameter.

19. The system of claim 18, wherein the sign parameter associated with each one of the point pairs is either positive or negative resulting from a difference between image intensities of the two image points of the respective one of the point pairs.

20. The system of claim 18, wherein the weight associated with each one of the point pairs is an absolute value of a difference between image intensities of the two image points of the respective one of the point pairs.

21. The system of claim 18, wherein a score parameter is determined by summing up the weights associated with at least some of the first plurality of point pairs.

22. The system of claim 18, wherein the normalization parameter is determined by summing up the weights of at least some of the point pairs of the first plurality of point pairs.

23. The system of claim 22, wherein the at least some of the point pairs of the first plurality of point pairs comprises only the point pairs of the first plurality of point pairs that have a respective corresponding point pair in the second plurality of point pairs.
